(19) United States
(12) Patent Application Publication
(10) Pub. No.: US 2026/0167881 A1
(43) Pub. Date: Jun. 18, 2026

(54) GAS PRODUCT MANUFACTURING USING VAPOR AND LIQUID COMPONENTS OF A FEEDSTOCK

(71) Applicant: InEnTec Inc., Richland, WA (US)

(72) Inventors: Dieter Olson, Richland, WA (US); Andrew Bennett, Richland, WA (US)

(73) Assignee: InEnTec Inc., Richland, WA (US)

(21) Appl. No.: 19/123,352

(22) PCT Filed: Oct. 25, 2022
(86) PCT No.: PCT/US2022/078667

§ 371 Date: Apr. 22, 2025

(51) Int. Cl. C10J 3/72; B01J 6/00; C01B 3/22; C10J 3/57; C10J 3/82

(52) U.S. Cl. CPC C10J 3/721; B01J 6/008; C01B 3/22; C10J 3/57; C10J 3/82; C01B 2203/0272; C10J 2300/0946; C10J 2300/1603; C10J 2300/1687; C10J 2300/1884

(57) ABSTRACT

An example gas product manufacturing system includes a first waste source, a heated enclosed vessel, and a thermal processing system (e.g., at least one gasifier). The first waste source is in fluid communication with the heated enclosed vessel and the heated enclosed vessel is in fluid communication with the thermal processing system. The first waste source is configured to provide a first waste product to the heated enclosed vessel. The heated enclosed vessel is configured to heat the first waste product to form a liquid phase and a vapor phase of the first waste product. The thermal processing system is configured to heat the liquid and vapor phases of the first waste product to form at least one gas product

### BACKGROUND

In gasifiers, organic materials can be converted into hydrogen rich gasses, synthesis gasses, which may be used as fuels, or which may be converted into other fuels, such as liquid methanol. Among these systems, it is also typical that the conversion of the synthesis gas and the solid vitrified material be accompanied by the production of a number of materials that are not desired. These materials include tars, oils, and carbon char that are typically found in the synthesis gas stream.

These systems allow waste products, which normally must be disposed of at some expense, to be converted into fuels, which can then be sold. In this manner, these types of systems convert a cost into revenue source. As a result, significant research and development related to improving these waste treatment systems is ongoing. Generally speaking, this research attempts to make these systems more efficient and less expensive.

### SUMMARY

In some embodiments, a gas product manufacturing system is disclosed. The gas product manufacturing system includes at least one first waste configured to provide a first waste product. The first waste product includes at least one solvent and one or more of at least one inorganic material or at least one organic material. The gas product manufacturing system includes at least one heated enclosed vessel including at least one vessel inlet in fluid communication with the first waste source. The at least one heated enclosed vessel is configured to form a liquid phase and a vapor phase of the first waste product. The at least one heated enclosed vessel includes at least one first vessel outlet positioned and equipped to output the liquid phase and at least one second vessel outlet positioned and equipped to output the vapor phase. The gas product manufacturing system includes at least one thermal processing system including at least one first processing inlet in fluid communication with the at least one first vessel outlet and at least one second processing inlet in fluid communication with the at least one second vessel outlet. The at least one thermal processing system is configured to heat the liquid phase of the first waste product and the vapor phase of the first waste product to form at least one gas product.

In some embodiments, a method to manufacture a gas product is disclosed. The method includes providing a first waste product from a first waste source to at least one heated enclosed vessel through at least one vessel inlet of the at least one heated enclosed vessel. The first waste product includes at least one solvent and one or more of at least one inorganic material or at least one organic material. The method also includes heating the first waste product received by the at least one heated enclosed vessel to form a liquid phase and a vapor phase of the first waste product, outputting the liquid phase and the vapor phase of the first waste product from the at least one heated enclosed vessel through at least one first vessel outlet and at least one second vessel outlet of the at least one heated enclosed vessel, receiving the liquid phase and the vapor phase of the first waste product with at least one first thermal inlet and at least one second thermal inlet, respectively, of at least one thermal processing system, and heating the liquid phase and the vapor phase of the first waste product to form at least one gas product.

In some embodiments, a gas product manufacturing system is disclosed. The gas product manufacturing system includes a first waste source configured to provide a first waste product. The first waste product includes at least one solvent and one or more of at least one inorganic material or at least one organic material. The gas product manufacturing system includes at least one heated enclosed vessel including at least one vessel inlet in fluid communication with the first waste source. The at least one heated enclosed vessel is configured to form a liquid phase and a vapor phase of the first waste product. The at least one heated enclosed vessel includes at least one first vessel outlet positioned and equipped to output the liquid phase and at least one second vessel outlet positioned and equipped to output the vapor phase. The gas product manufacturing system includes a second waste source configured to provide a second waste product that is different than the first waste product. The second waste source is not in fluid communication with the at least one heated enclosed vessel. The gas product manufacturing system includes at least one gasifier in fluid communication with the at least one first vessel outlet and the second waste source. The at least one gasifier is configured to heat at least the liquid phase of the first waste product and the second waste product to form at least one gas product.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein similar reference numerals refer to identical or similar elements or features in different views or embodiments shown in the drawings.

FIG. 1 is a schematic illustration of a gas product manufacturing system, according to an embodiment.

FIG. 2 is a schematic illustration of a gas product manufacturing system, according to an embodiment.

FIG. 3 is a schematic illustration of a gas product manufacturing system, according to an embodiment.

FIG. 4 is a flow chart of a method of using any of the gas product manufacturing systems disclosed herein, according to an embodiment.

### DETAILED DESCRIPTION

Embodiments are directed to gas product manufacturing systems including a heated enclosed vessel coupled to a gasifier, and methods of using the same. An example gas product manufacturing system includes a first waste source, a heated enclosed vessel, and a thermal processing system (e.g., at least one gasifier). The first waste source is in fluid communication with the heated enclosed vessel and the heated enclosed vessel is in fluid communication with the thermal processing system. The first waste source is configured to provide a first waste product to the heated enclosed vessel. The heated enclosed vessel is configured to heat the first waste product to form a liquid phase and a vapor phase of the first waste product. The thermal processing system is configured to heat the liquid and vapor phases of the first waste product to form at least one gas product.

During use, the first waste source provides the first waste product to the heated enclosed vessel. The first waste product include at least one solvent (e.g., water) and one or more of at least one organic material or at least one inorganic material. The heated enclosed vessel heats the first waste product to form the vapor phase of the first waste product while maintaining a portion of the first waste product in the liquid phase. The heated enclosed vessel provides the liquid and vapor phases of the first waste product to the thermal processing system. In some embodiments, the heated enclosed vessel may provide the liquid and vapor phases separately to the thermal processing system thereby allowing the liquid and vapor phases to be provided to the thermal processing system via separate conduits to inhibit the vapor phase from returning to the liquid phase. Upon receiving the liquid and vapor phases of the first waste product, the thermal processing system heats the liquid and vapor phases of the first waste product to form at least one gas product, such as synthesis gas (“syngas”). The thermal processing system may include one or more components (e.g., an additional gasifier, gas cooler, gas cleaner, sulfur removal device, hydrogen producer, etc.) that are configured to further process the at least one gas product.

Conventional gas product manufacturing systems are configured to receive and gasify a waste product, but liquid waste (notably solvent wastes) acts as a heat sink in the gasifier. Gasifying the liquid waste product may be energy and time intensive, for example, when the waste product includes a material having a relatively high heat capacity (e.g., water). The energy required to gasify the waste product makes the conventional gas product manufacturing systems inefficient. The time required to gasify the waste product limits the rate at which the waste product that may be gasified. For example, providing the waste product that includes a material having a relatively high heat capacity at a quantity and/or rate above a threshold value may cause the temperature of the conventional gas product manufacturing system to decrease. The decreased temperature of the conventional gas product manufacturing system reduces the quality of the gas product formed therein or may prevent more waste product being provided to the conventional gas product manufacturing system until the temperature of the conventional gas product manufacturing system is increased.

The gas product manufacturing systems and methods of using the gas product manufacturing systems disclosed herein resolve at least some of these issues associated with at least some conventional gas product manufacturing systems and methods of using such conventional gas product manufacturing systems. For example, the gas product manufacturing systems disclosed herein include the heated enclosed vessel. The heated enclosed vessel vaporizes a portion of the first waste product to form a vapor phase of the first waste product. The heated enclosed vessel also increases the thermal energy in the liquid first waste product, which decreases the latent heat of vaporization of the remaining liquid phase of the first waste product. Providing the heated liquid phase and the vapor phase of the first waste product to the thermal processing system decreases the energy and time required for the thermal processing system to gasify the first waste product. For example, the inclusion of the heated enclosed vessel in the gas product manufacturing systems disclosed herein allows the quantity and/or rate of the first waste product provided to the thermal processing system to be increased without having an unsatisfactory drop of temperature in the thermal processing system. The overall time and energy used by the gas product manufacturing systems disclosed herein to gasify the first waste product is less than if the gas product manufacturing systems did not include the heated enclosed vessel. Further, the heated enclosed vessel decreases the workload of one or more components of the thermal processing system (e.g., decreases the workload of the gasifier(s)). Decreasing the workload of the thermal processing system decreases the likelihood that the thermal processing system needs repair or replacing. It is noted that the heated enclosed vessel increases the number of components of the gas product manufacturing system that may need repair or replacement but it is significantly easier, quicker, and/or cheaper to repair or replace the heated enclosed vessel than at least some other components of the thermal processing system (e.g., the gasifier(s)).

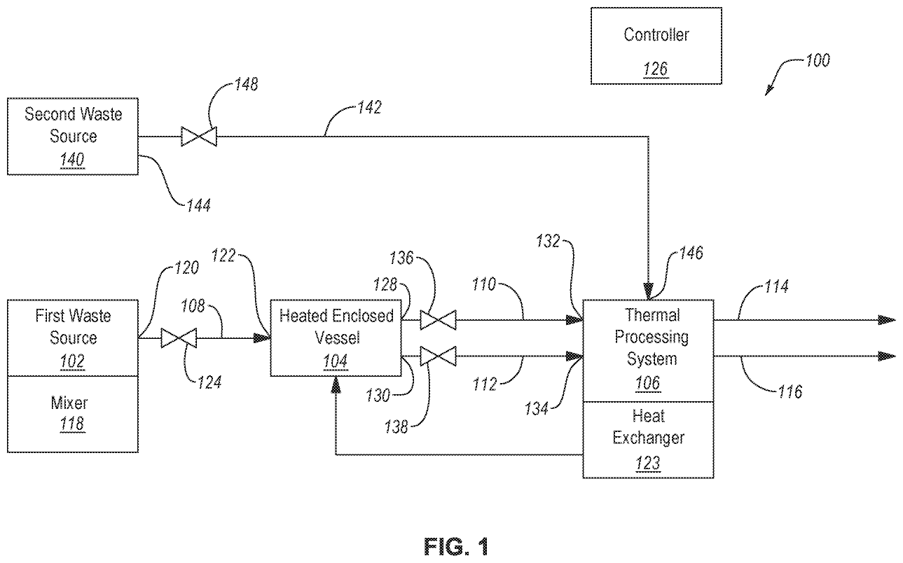

FIG. 1 is a schematic illustration of a gas product manufacturing system 100, according to an embodiment. The gas product manufacturing system 100 includes at least one first waste source 102, at least one heated enclosed vessel 104, and at least one thermal processing system 106. The first waste source 102 is sized, shaped, positioned, and equipped (e.g., configured) to provide a first waste product 108 to the heated enclosed vessel 104. The heated enclosed vessel 104 is sized, shaped, positioned, and equipped (e.g., configured) to vaporize a portion of the first waste product 108 received therein and maintain a portion of the first waste product 108 in liquid form. The heated enclosed vessel 104 is sized, shaped, positioned, and equipped (e.g., configured) to output a liquid phase 110 and a vapor phase 112 of the first waste product 108 and provide the liquid phase 110 and the vapor phase 112 to the thermal processing system 106. The thermal processing system 106 heats at least the liquid phase 110 and the vapor phase 112 to form at least one or more gas products. In the illustrated embodiment, the thermal processing system 106 is sized, shaped, positioned, and equipped (e.g., configured) to form synthesis gas (“syngas”) 114 and one or more other products 116. The other products 116 may include, for example, metals, glass, tail gas, sulfur, waste water, inorganic waste, other waste, or combinations thereof.

In some embodiments, the first waste source 102 includes one or more pipes extending from a waste producing entity (e.g., a waste producing factory) that connects the waste producing entity to the rest of the gas product manufacturing system 100. In some embodiments, the first waste source 102 includes a tank. The tank of the first waste source 102 may be connected to the waste producing entity using one or more pipes, gutters, or other conduits. The first waste source 102 that includes the tank may provide one or more benefits over the first waste source 102 that does not include a tank. For example, the tank may store excess quantities of the first waste product 108 therein when the rate that the first waste product 108 is provided is greater than the downstream components of the gas product manufacturing system 100 may handle. The tank may then store the excess quantities of the first waste product 108 until the gas product manufacturing system 100 has the ability to handle such excess quantities. In some embodiments, the first waste source 102 is a tank on a truck, train, or other vehicle when the rest of the gas product manufacturing system 100 is remote from the waste producing entity.

It is noted that, in some embodiments, the first waste product 108 may separate into a plurality of different compositions (e.g., into different layers or phases) if left in the tank for a period of time. The gas product manufacturing system 100 may be able to process each of the different compositions of the first waste product 108 though the gas product manufacturing system 100 may need different operating characteristics to process the different compositions efficiently. For example, different compositions of the first waste product 108 may require the heated enclosed vessel 104 to exhibit different temperatures to vaporize a desired percentage of the first waste product 108. To resolve this problem, in some embodiments, the gas product manufacturing system 100 may include a mixer 118 disposed in or otherwise coupled to the first waste source 102. The mixer 118 may include a turbulence inducing element or other element positioned or equipped to prevent or at least inhibit separation of the first waste product 108 into different compositions. In other words, the mixer 118 may better ensure that the composition of the first waste product 108 provided to the rest of the gas product manufacturing system 100 remains relatively constant.

As previously discussed, the first waste source 102 is sized, shaped, positioned, and equipped to temporarily store the first waste product 108 therein. The first waste product 108 may include at least one solvent and one or more of at least one inorganic material or at least one organic material. The at least one solvent may include a liquid, such as water, acetone, alcohols (e.g., butanol, ethanol, isopropanol), benzene, dichloromethane, trichloroetheylene, carbon tetrachloride, propylene glycol methyl ether acetate, propylene glycol methyl ether, n-methyl pyrrolidone, dimethyl sulfoxide, ethylene glycols, or any other solvent. The at least one solvent may form, by weight, about 5% or more of the first waste product 108, such as about 10% or more, about 20% or more, about 30% or more, about 40% or more, about 50% or more, about 60% of more, about 70% or more, about 80% or more, about 90% or more, about 95% or more, or in ranges of about 5% to about 20%, about 10% to about 30%, about 20% to about 40%, about 30% to about 50%, about 40% to about 60%, about 50% to about 70%, about 60% to about 80%, about 70% to about 90%, or about 80% to about 95% of the first waste product 108. In particular examples, the solvent may include water forming at least about 20%, by weight, of the first waste product 108. In some embodiments, the inorganic materials may include one or more calcium-bearing minerals, one or more metals (e.g., alkaline metals, alkaline earth metals, transition metals, metalloids), one or more metal alloys, one or more glasses, or combinations thereof. The inorganic materials may be at least one of at least partially soluble or at least partially insoluble in the solvent. In some embodiments, the organic materials may include one or more biomasses (e.g., ash, woodchips, coconut shells, cocoa, coffee husks, etc.), one or more polymers, one or more other carbon-containing compounds, refuse-derived fuel, sewage, other solid organic material, or combinations thereof. In some embodiments, the first waste product includes at least one of municipal waste, agricultural waste, or industrial waste.

In some embodiments, the first waste product 108 may include at least one high heat capacity material forming, by weight, about 15% or more of the first waste product 108. As used herein, a high heat capacity material includes a material exhibiting a heat capacity that is at least one of about 2 joules/(gram*Kelvin) (“J/gK”), about 3 joules/gK or greater, or about 4 J/gK or greater. It has been found that it requires significantly more time and energy to gasify a waste product that includes at least one high heat capacity material forming at least 15% or more of the waste product. However, as previously discussed, partially vaporizing the first waste product 108 in the heated enclosed vessel 104 prior to introduction into the thermal processing system 106 significantly decreases the overall time and energy required to gasify a waste product that includes at least one high heat capacity material forming at least 15% or more of the waste product.

The first waste source 102 includes a first waste outlet 120. The first waste outlet 120 is positioned and equipped to allow the first waste product 108 to leave the first waste source 102. The waste outlet 120 is in fluid communication with the heated enclosed vessel 104. For example, the heated enclosed vessel 104 includes a vessel inlet 122 that is in fluid communication with the first waste outlet 120 thereby allowing the heated enclosed vessel 104 to receive the first waste product 108 dispensed from the first waste source 102. In some embodiments, the first waste outlet 120 may be directly connected to a vessel inlet 122 of the heated enclosed vessel 104. In some embodiments, the first waste outlet 120 is indirectly connected to the vessel inlet 122 via one or more pipes or conduits.

The gas product manufacturing system 100 may include a first valve 124 that is sized, shaped, positioned, and equipped (e.g., configured) to control flow of the first waste product 108 from the first waste source 102 to the heated enclosed vessel 104. The first valve 124 may be positioned in the first waste source 102 (e.g., at or near the first waste outlet 120), the heated enclosed vessel 104 (e.g., at or near the vessel inlet 122), or the one or more pipes connecting the waste outlet 120 to the vessel inlet 122. As will be discussed in more detail below, the first valve 124 may be at least partially controlled by a controller 126.

The heated enclosed vessel 104 includes a chamber extending from the vessel inlet 122. The chamber is sized, shaped, positioned, and equipped (e.g., configured) to receive and temporarily store the first waste product 108. The heated enclosed vessel 104 is equipped to heat the first waste product 108 that is in the chamber to partially vaporize the first waste product 108. In some embodiments, the chamber of the heated enclosed vessel 104 forms a tortuous path therethrough and/or a plurality of branching paths which may facilitate heating the first waste product 108 therein. In some embodiments, the heated enclosed vessel 104 is at least one of a reboiler, a flash tank or other device sized, shaped, and equipped (e.g., configured) for flash distillation, a steam generator, or a heat exchanger (e.g., a shell and tube heat exchanger).

In some embodiments, the heated enclosed vessel 104 is equipped to directly heat the first waste product 108. In such an embodiment, the heated enclosed vessel 104 includes a heating element (e.g., resistive heater), electromagnetic heater (e.g., microwave emitter, induction heater), or a combustion heat source (e.g., burner) disposed in thermal communication with the chamber, such as in or around the chamber. In some embodiments, the heated enclosed vessel 104 is equipped to indirectly heat the first waste product 108. In such an embodiment, the heating element or heat source of the heated enclosed vessel 104 is disposed outside of the chamber. In some embodiments, the heated enclosed vessel 104 is equipped to indirectly heat the first waste product 108 using steam. In such an embodiment, the heated enclosed vessel 104 includes a secondary chamber that is separate from and thermally coupled to the chamber. The secondary chamber is sized, shaped, and equipped (e.g., configured) to have the steam flow therethrough and at least some of the heat from the steam is transferred to the chamber and contents therein.

In some embodiments, the heated enclosed vessel 104 is equipped to be used, at least in part, using waste thermal energy from the thermal processing system 106. For example, sources of thermal energy that may be present in the thermal processing system 106 may include heat from the gasifier(s) of the thermal processing system 106, heat removed from the gas products discharged from the gasifier(s), or molten metals or glass removed from the gasifier(s). The gas product manufacturing system 100 may include at least one heat exchanger 123 that is positioned and equipped to receive at least some of the waste thermal energy from the thermal processing system 106 or products emitted therefrom. In some embodiments, the heat exchanger 123 is in thermal communication with the heated enclosed vessel 104 such that the waste thermal energy received thereby may be used to heat the heated enclosed vessel 104. For instance, the heat exchanger 123 may use the waste thermal energy received thereby to heat or produce steam and the steam may be used to heat the heated enclosed vessel 104, as previously discussed.

The heated enclosed vessel 104 is sized, shaped, and equipped (e.g., configured) to vaporize at least a portion of at least one volatile component of the first waste product 108. As used herein, the volatile component refers to component(s) of the first waste product 108 that exhibit boiling temperatures that are lower than, vaporize quicker, or are otherwise easier to vaporize than other components of the first waste product 108. In some embodiments, the volatile component of the first waste product 108 may include the high heat capacity material(s), water, an organic solvent (e.g., alcohols), another solvent, an inorganic material, or an organic material. Vaporizing the volatile component results in the vapor phase 112 of the first waste product 108 exhibiting a higher concentration of the volatile component than the liquid phase 110 of the first waste product 108. In other words, the liquid phase 110 may exhibit a higher concentration of non-volatile components than the vapor phase 112. It is noted that the liquid phase 110 may include some of the volatile component due to incomplete vaporization of the volatile component(s), condensation, etc. The vapor phase 112 may also include some of the non-volatile component(s) due to vaporization, etc.

The heated enclosed vessel 104 may be heated to a temperature that is sufficient to vaporize (e.g., boil, flash distillation, etc.) at least a portion of the volatile component(s) of the first waste product 108. For example, when the solvent is water, the heated enclosed vessel 104 may be equipped to be heated to a temperature of about 100° C. or greater, such as about 110° C. or greater, about 120° C. or greater, about 130° C. or greater, about 140° C. or greater, about 150° C. or greater, about 175° C. or greater, about 200° C. or greater, or in ranges of about 100° C. to about 120° C., about 110° C. to about 130° C., about 120° C. to about 140° C., about 130° C. to about 150° C., about 140° C. to about 175° C., or about 150° C. to about 200° C. As used herein, the temperature of the heated enclosed vessel 104 includes at least one of the temperature of one or more surfaces defining the chamber before or after the first waste product 108 is introduced into the chamber, the temperature of air in the chamber before or after the first waste product 108 is introduced into the chamber, the temperature of the liquid phase 110 and/or the vapor phase 112 exiting the heated enclosed vessel 104, or the temperature of the heating element or heat source (e.g., steam) used to heat the chamber.

The temperature of the heated enclosed vessel 104 may be selected based on a number of factors. The temperature of the heated enclosed vessel 104 may be selected based on the composition of the first waste product 108. For instance, the temperature of the heated enclosed vessel 104 may be selected to be less than 100° C. when the volatile component of the first waste product 108 does not include water and, instead, includes at least one component that is easier to vaporize than water. In some embodiments, the temperature of the heated enclosed vessel 104 may be selected based on the pressure within the chamber. For instance, the temperature of the heated enclosed vessel 104 may be increased as the pressure inside the chamber is increased to continue to vaporize a desired percentage of the first waste product 108. In some embodiments, the temperature of the heated enclosed vessel 104 may be selected based on the desired percentage of the first waste product 108 to be vaporized. For instance, the temperature of the heated enclosed vessel 104 may be increased when the desired percentage of the first waste product 108 to be vaporized is also increased. The temperature of the heated enclosed vessel 104 may be selected based on a feed rate of the first waste product 108 into the heated enclosed vessel or feed rate of liquid phase 110 and/or the vapor phase 112 into the thermal processing system 106. The temperature of the heated enclosed vessel 104 may be selected based on the time that the first waste product 108 is present in the chamber which, in turn, may be selected based on the rate at which the first waste product 108 is provided to the heated enclosed vessel 104. For instance, the temperature of the heated enclosed vessel 104 may be increased when the time that the first waste product 108 is present in the chamber is decreased.

As previously discussed, the heated enclosed vessel 104 is configured to vaporize a desired percentage of the first waste product 108. For example, the heated enclosed vessel 104 may be sized, shaped, and equipped to vaporize, by weight, about 5% or more of the first waste product 108, such as about 10% or more, about 20% or more, about 30% or more, about 40% or more, about 50% or more, about 60% or more, about 70% or more, about 80% or more, about 90% or more, about 95% or more, or in ranges of about 5% to about 20%, about 10% to about 30%, about 20% to about 40%, about 30% to about 50%, about 40% to about 60%, about 50% to about 70%, about 60% to about 80%, about 70% to about 90%, or about 80% to about 95% of the first waste product 108. The percentage of the first waste product 108 that is vaporized may be selected based on a number of factors. In some embodiments, the percentage of the first waste product 108 that is vaporized may be selected based on the temperature of the heated enclosed vessel 104 and/or the pressure inside the chamber. In some embodiments, the percentage of the first waste product 108 that is vaporized by may be selected based on the composition of the first waste product 108. In some embodiments, the percentage of the first waste product 108 may be selected based on the desired composition of the liquid phase 110 and the vapor phase 112. For instance, increasing the percentage of the first waste product 108 that is vaporized may decrease and increase the quantity of volatile component(s) that are in the liquid phase 110 and the vapor phase 112. Decreasing the quantity of the volatile component(s) that are in the liquid phase 110 may undesirably increase the viscosity of the liquid phase 110 and/or make the liquid phase 110 a solid, especially when the volatile component(s) form the solvent. In some embodiments, the percentage of the first waste product 108 that is vaporized may be selected to prevent the first waste product 108 from exploding. For instance, it has been found that the first waste product 108 may explode when too much is vaporized depending on the composition of the first waste product 108 (e.g., the first waste product 108 may include at least one oxidant and at least one fuel when vaporized). However, vaporizing less than a threshold percentage of the first waste product 108 prevents or at least inhibits the first waste product 108 from exploding. The threshold percentage varies depending on the composition of the first waste product 108 but, in some embodiments, may be greater than 80% by weight.

In some embodiments, the chamber of the heated enclosed vessel 104 may be configured to exhibit an elevated pressure that is greater than about 100 kPa (e.g., about 1 atmosphere) when the first waste product 108 is being vaporized. For example, the chamber of the heated enclosed vessel 104 may be sized, shaped, and equipped to exhibit an elevated pressure that is about 500 kPa to about 2000 kPa, about 1500 kPa to about 3000 kPa, or about 2500 kPa to about 4000 kPa. The elevated pressure of the chamber may be used to at least one control the percentage of the first waste product 108 that is vaporized, allow the liquid phase 110 to exhibit a higher temperature, or promote flow of the liquid and vapor phases 110, 112 from the heated enclosed vessel 104 to the thermal processing system 106. In some embodiments, the chamber of the heated enclosed vessel 104 may be sized, shaped, and equipped to exhibit a depressed pressure that is less than 1 atm (about 100 kPa) when the first waste product 108 is being vaporized. For example, the chamber of the heated enclosed vessel 104 may be sized, shaped, and equipped to exhibit a depressed pressure that is about 50 kPa to about 75 kPa or about 70 kPa to about 95 kPa. The depressed pressure may increase the percentage of the first waste product 108 that is vaporized at any given temperature. Since the vapor phase 112 may exhibit a lower heat capacity than the originally provided first waste product 108, the depressed pressure may make it easier to increase the average temperature of the first waste product 108. However, the depressed pressure may limit the temperature that the liquid phase 110 may be heated to, which may increase the workload on the thermal processing system 106. In some embodiments, the chamber of the heated enclosed vessel 104 may be sized, shaped, and equipped to exhibit about 100 kPa when the first waste product 108 is being vaporized. It is noted that the pressures disclosed in this paragraph refer to the absolute pressure.

The first waste product 108 exhibits an initial temperature when the first waste product 108 is introduced to the heated enclosed vessel 104. The initial temperature may be about ambient temperature (e.g., about 15° C. to about 30° C.) or otherwise less than a boiling temperature of the first waste product 108. The heated enclosed vessel 104 heats the first waste product 108 such that the first waste product 108 exhibits an elevated temperature that is greater than the initial temperature when the first waste product 108 is dispensed from the heated enclosed vessel 104. The increased final temperature of the first waste product 108 decreases the amount of energy and time required to gasify the first waste product 108. In other words, the heated enclosed vessel 104 decreases the latent heat of vaporization of the liquid phase 110 (and vapor phase 112) of the first waste product 108.

It is noted that the final temperature of the liquid and vapor phases 110, 112 may be different. For example, the final temperature of the liquid phase 110 may be at or near the boiling temperature of the liquid phase 110 while the final temperature of the vapor phase 112 may be at or above the boiling temperature of the liquid phase 110. In some embodiments, when the chamber exhibits an elevated pressure, the final temperature of the liquid phase 110 may be greater than the boiling temperature of the liquid phase 110 at about 100 kPa. In such an embodiment, introducing the liquid phase 110 into the gasifier(s) of the thermal processing system 106 may result in near instantaneous vaporization of the liquid phase 110 depending on the pressure within the gasifier(s).

In some embodiments, the heated enclosed vessel 104 includes at least one first vessel outlet 128 and at least one second vessel outlet 130. The first and second vessel outlets 128, 130 are sized, shaped, and positioned (e.g., configured) to provide the liquid and vapor phases 110, 112, respectively, to the thermal processing system 106. It is noted that the first and second vessel outlets 128, 130 may inadvertently provide the vapor and liquid phases 112, 110, respectively, to the thermal processing system 106. In some embodiments, the second vessel outlet 130 may be located gravimetrically higher than and/or downstream from the first vessel outlet 128. In such an example, the first vessel outlet 128 may remove substantially all of the liquid phase 110 before the liquid phase 110 may reach the second vessel outlet 130. The heated enclosed vessel 104 that includes both the first vessel outlet 128 and the second vessel outlet 130 allows the gas product manufacturing system 100 to provide the liquid and vapor phases 110, 112 to different locations of the thermal processing system 106, as will be discussed in more detail below. Also, the heated enclosed vessel 104 that includes both the first vessel outlet 128 and the second vessel outlet 130 allows for additional control on the percentage of the first waste product 108 that is vaporized, as will be discussed in more detail below with regards to the second and third valves 136, 138. The thermal processing system 106 includes at least one first thermal processing inlet 132 and at least one second thermal processing inlet 134 that is in fluid communication with the first vessel outlet 128 and the second vessel outlet 130. The first vessel outlet 128 may be directly or indirectly (e.g., via one or more pipes) connected to the first thermal processing inlet 132 and the second vessel outlet 130 may be directly or indirectly (e.g., via one or more pipes) connected to the second thermal processing inlet 134.

The gas product manufacturing system 100 includes a second valve 136 and a third valve 138. The second valve 136 is sized, shaped, positioned, and equipped to control flow of the liquid phase 110 from the heated enclosed vessel 104 to the thermal processing system 106 and the third valve 138 is sized, shaped, positioned, and equipped to control flow of the vapor phase 112 from the heated enclosed vessel 104 to the thermal processing system 106. The second and third valves 136, 138 may be independently selected to be in the heated enclosed vessel 104 (e.g., at or near the first vessel outlet 128 and/or the second vessel outlet 130), the thermal processing system 106 (e.g., at or near the first thermal processing inlet 132 and/or the second thermal processing inlet 134), or the one or more pipes connecting the waste outlet 120 to the vessel inlet 122 may include a first valve 124. The second and third valves 136, 138 may be used to at least partially control the percentage of the first waste product 108 that is vaporized. In some embodiments, partially closing both the second and third valves 136, 138 may increase the pressure in the chamber which, in turn, may decrease the percentage of the first waste product 108 that is vaporized. In some embodiments, partially closing the second valve 136 while maintaining the third valve 138 open may increase the time that the first liquid product is in the chamber which, in turn, may increase the percentage of the first waste product that is vaporized. In some embodiments, partially closing the third valve 138 while maintaining the second valve 136 open may increase the pressure in the chamber and/or decrease the time that the first waste product 108 spends in the chamber which, in turn, decreases the percentage of the first waste product 108 that is vaporized. As will be discussed in more detail below, the second and third valves 136, 138 may be at least partially controlled by a controller 126.

In some embodiments, not shown, the heated enclosed vessel 104 does not include different vessel outlets to provide the liquid and vapor phases 110, 112 to the thermal processing system 106. In such embodiments, the heated enclosed vessel 104 may include at least one common vessel outlet that is sized, shaped, and located to provide both the liquid and vapor phases 110, 112 to the thermal processing system 106. The thermal processing system 106 may include at least one thermal processing inlet sized, shaped, and located (e.g., configured) to receive the liquid and vapor phases 110, 112 from the common vessel outlet. The gas product manufacturing system 100 may also include a valve sized, shaped, and equipped (e.g., configured) to control flow of the liquid and vapor phases 110, 112 between the heated enclosed vessel 104 and the thermal processing system 106.

In some embodiments, the gas product manufacturing system 100 includes at least one second waste source 140 sized, shaped, and equipped (e.g., configured) to temporarily store a second waste product 142. Except as otherwise disclosed herein, the second waste source 140 may be the same as or substantially similar to any of the first waste sources disclosed herein. In some embodiments, the second waste source 140 includes a pipe extending from a waste producing entity (e.g., a waste producing factory) that connects the waste producing entity to the rest of the gas product manufacturing system 100. In some embodiments, the second waste source 140 includes a tank connected to the waste producing entity. In some embodiments, second waste source 140 includes a tank on a truck, train, or other vehicle that carries the second waste product 142 from waste producing entity to the thermal processing system 106 that is remote from the waste producing entity. In some embodiments, when the second waste source 140 includes a tank, the second waste source 140 may include a mixer (not shown) to prevent the second waste product 142 from separating.

As previously discussed, the second waste source 140 is sized, shaped, and equipped to temporarily store the second waste product 142 therein. The second waste product 142 may be different than the first waste product 108 in one or more aspects. The second waste product 142 may include one or more of at least one solvent, at least one inorganic material, or at least one organic material as disclosed herein with respect to the first waste product 108. For example, the solvent, inorganic material, and the organic material of the second waste product 142 may be selected from any of the components of the first waste product 108. In some embodiments, the second waste product 142 does not include a high heat capacity material or includes a lower concentration of at least one high heat capacity material than the first waste product 108. In such embodiments, the second waste product 142 may be more quickly and energy efficiently gasified by the thermal processing system 106 than the first waste product 108.

The second waste source 140 includes a second waste outlet 144. The second waste outlet 144 is sized, shaped, and located (e.g., configured) to allow the second waste product 142 to leave the second waste source 140. The second waste outlet 144 is in fluid communication with the thermal processing system 106 thereby allowing the second waste product 142 to bypass the heated enclosed vessel 104. The thermal processing system 106 may include a third thermal processing inlet 146 that is in fluid communication with the second waste outlet 144 thereby allowing the thermal processing system 106 to receive the second waste product 142 dispensed from the second waste source 140. The third thermal processing inlet 146 may be formed in the same component or different components of the thermal processing system 106 than at least one of the first thermal processing inlet 132 or the second thermal processing inlet 134. In some embodiments, the second waste outlet 144 may be directly connected to third thermal processing inlet 146 of the thermal processing system 106. In some embodiments, the second waste outlet 144 is indirectly connected to the third thermal processing inlet 146 via one or more pipes.

The gas product manufacturing system 100 may include a fourth valve 148 sized, shaped, positioned, and equipped (e.g., configured) to control flow of the second waste product 142 from the second waste source 140 to the thermal processing system 106. The fourth valve 148 may be positioned in second waste source 140 (e.g., at or near the second waste outlet 144), the thermal processing system 106 (e.g., at or near the vessel inlet 122), or the one or more pipes connecting the second waste outlet 144 to the third thermal processing inlet 146. As will be discussed in more detail below, the fourth valve 148 may be at least partially controlled by a controller 126.

The thermal processing system 106 is equipped to receive and gasify the liquid phase 110 and the vapor phase 112 of the first waste product 108 and, optionally, the second waste product 142 to form at least one or more gas products. The thermal processing system 106 may also be equipped to process the one or more gas products formed thereby, for example, to remove impurities from the one or more gas products or separate the components of the gas products. The thermal processing system 106 may also be equipped to product other non-gas products, such as one or more metals, one or more glasses, waste water, etc.

In some embodiments, the thermal processing system 106 is equipped to produce syngas 114. Syngas may primarily include hydrogen (H₂), carbon monoxide (CO), and carbon dioxide (CO₂). The output of the gasifier may also include water vapor (H₂O), methane (CH₄), carbon sulfide (H₂S), ammonia (NH₃), or hydrogen chloride (HCl). Syngas may be used to produce some useful chemicals, such as natural gas, ammonia, or methanol. The syngas 114 may also be used as fuel or to create liquid fuels.

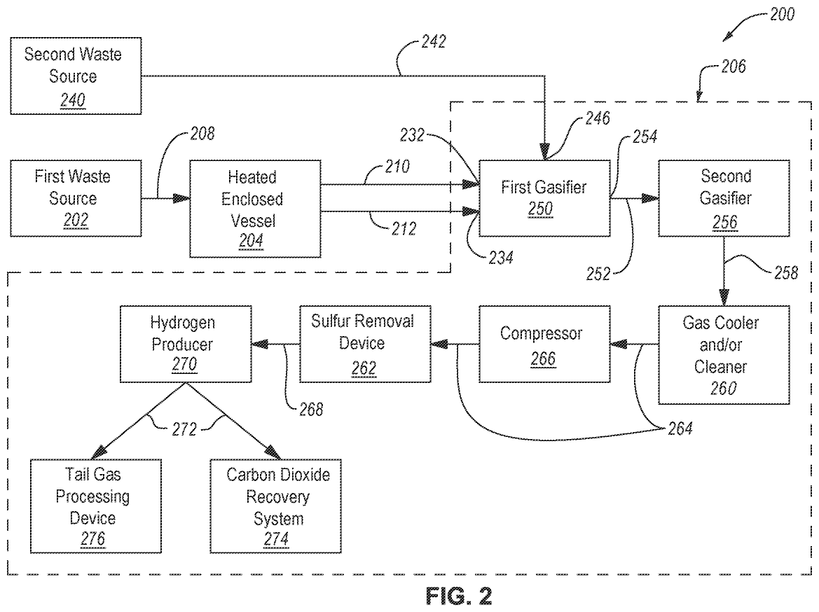

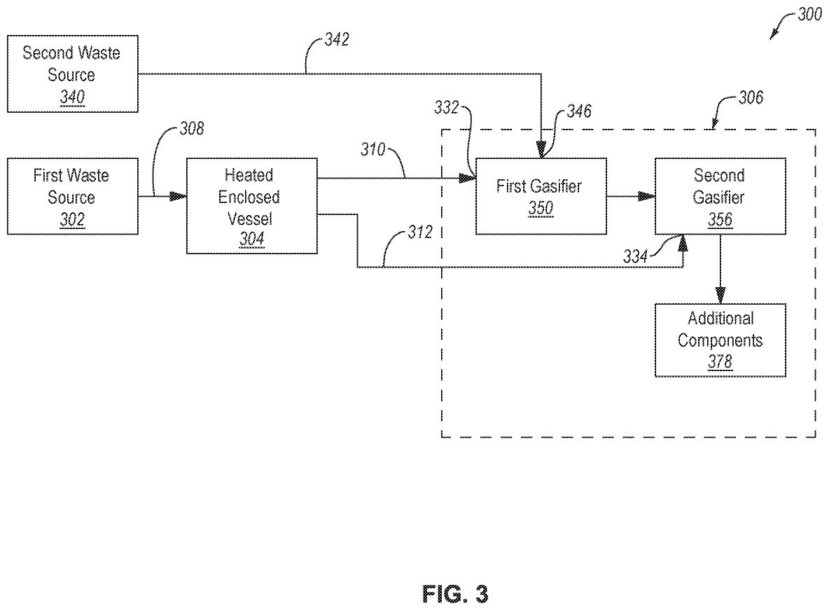

The thermal processing system 106 may include any device equipped to gasify waste products, produce one or more gas products (e.g., syngas 114), process one or more gas products, or produce one or more non-gas products (molten metal, molten glass). In some embodiments, the thermal processing system 106 may include one or more conventional thermal processing systems or components of such conventional thermal processing systems. In some embodiments, the thermal processing system 106 may include the thermal processing systems illustrated in FIGS. 2 and 3 which, as will be discussed in more detail below, are specifically equipped to process the liquid and vapor phases 110, 112 and may be an improvement over conventional thermal processing systems.

In an embodiment, the thermal processing system 106 includes at least one gasifier configured (e.g., sized, shaped, positioned, and equipped) to receive and gasify the first waste product 108 and the optional second waste product 142. The gasifier of the thermal processing system 106 may include a joule heating gasifier, an induction heating gasifier, or any other suitable gasifier. In some embodiments, the gasifier of the thermal processing system 106 defines a processing chamber sized, shaped, positioned, and equipped (e.g., configured) to convert at least a portion of the first waste product 108 and the second waste product 142 into one or more gas products. The gasifier of the thermal processing system 106 may include a plurality of ports and a plurality of electrodes. For example, the gasifier of the thermal processing system 106 may include at least one first port in fluid communication with the first, second, and third thermal processing inlets 132, 134, 146 that is sized, shaped, positioned, and equipped (e.g., configured) to introduce the first and second waste products 108, 142 into the processing chamber. The gasifier of the thermal processing system 106 may also include at least one second port sized, shaped, positioned, and equipped to provide oxygen to the processing chamber and at least one third port sized, shaped, positioned, and equipped to provide material (e.g., inorganic material) into the processing chamber. The plurality of electrodes may include at least one first electrode located and equipped to induce reactions between the at least the first waste product 108 and the oxygen to form at least syngas and/or at least one second electrode located and equipped to provide joule heating that is sufficient to form and maintain a molten inorganic (e.g., glass) bath within the processing chamber. The energy provided to the processing chamber using the first and second electrodes may heat the processing chamber to a sufficient temperature (e.g., to gasifier at least a portion of the first waste product 108 and the optional second waste material 142). The gasifier of the thermal processing system 106 may include an outlet that allows the one or more gas products generated in the processing chamber to leave the processing chamber.

In some embodiments, the gasifier of the thermal processing system 106 may include a vessel (e.g., refractory-lined vessel, a steel vessel, a vertical vessel, or combinations thereof). The gasifier of the thermal processing system 106 may contain a bath of molten inorganic material (e.g., glass) within the vessel. The gasifier of the thermal processing system 106 may be positioned and equipped within the system 100 to have the bath of molten inorganic material periodically supplemented by adding additional inorganic material (e.g., glass cullet) to the vessel. It is noted that the inorganic material may also be supplemented by the removal of inorganic material from the first waste product 108 and the second waste product 142. The molten inorganic material may be heated by a combination of alternating current (AC) electrodes in the molten inorganic material bath plus heat from plasma arcs created by running direct current (DC) from graphite electrodes through a gas gap into the molten inorganic material. The first waste product 108 and the optional second waste product 142 maybe provide into the vessel, such as provided onto the top of the molten inorganic material bath in the vicinity of the plasma arcs. The high temperatures of the plasma arcs and the molten inorganic material bath (about 1000° C. to about 1500° C.) convert at least a portion of the first waste product 108 and the second waste product 142 to one or more gas products and melt the remaining material components of the first and second waste products 108, 142. Certain metals that melt into the molten inorganic material may settle to the bottom of the molten inorganic material bath and can be periodically drained. The remaining inert molten inorganic material may be removed by periodically draining the molten inorganic material bath into ingot molds. Steam (if necessary) and oxygen may be added to the vessel, such as above the molten inorganic material bath, to assist with the gasification. The steam, if necessary, will be used to provide hydrogen for the desired reactions, and the oxygen will be used to partially oxidize organic material. In some embodiments, the DC electrodes are used to initially bring the gasifier of the thermal processing system 106 up to operating temperature, and once hot, the gasifier of the thermal processing system 106 is kept hot by the AC electric heating to minimize re-start time and to improve refractory life. Energy input from the DC electrodes is adjusted based on the characteristics and rate of the first and second waste products 108, 142 provided to the gasifier of the thermal processing system 106.

Further examples of thermal processing systems and/or components that may be included in the thermal processing system 106 are disclosed in U.S. Pat. No. 8,525,085 filed on May 10, 2010; U.S. Pat. No. 8,118,892 filed on May 23, 2008; U.S. Pat. No. 9,150,805 filed on May 25, 2010; U.S. Pat. No. 8,614,364 filed on Oct. 7, 2009; U.S. Pat. No. 9,057,032 filed on May 25, 2010; and U.S. Pat. No. 7,854,775 filed on May 12, 2006; the disclosures of each of which are incorporated herein, in its entirety, by this reference.

In some embodiments, the gas product manufacturing system 100 includes one or more sensors (not shown) that are positioned and equipped to detect one or more characteristics of the gas product manufacturing system 100. In some embodiments, the sensors may include one or more flow sensors, such as a mechanical flow meter, a pressure-based flow meter, a velocity sensor, or any other flow meter. The flow meter may be positioned and equipped to detect the flow of at least one of the first waste product 108 through the first waste source 102, the first waste product 108 from the first waste source 102 to the heated enclosed vessel 104, the first waste product 108 through the heated enclosed vessel 104, the first waste product 108 (e.g., the liquid phase 110 and/or the vapor phase 112) from the heated enclosed vessel 104 to the thermal processing system 106, the second waste product 142 through the second waste source 140, the second waste product 142 from the second waste source 140 to the thermal processing system 106, or one or more gas products or other products through the thermal processing system 106. In some embodiments, the sensors may include one or more temperature sensors, such as infrared thermometer, resistance thermometer, a temperature gauge, a thermistor, or any other suitable temperature sensor. The temperature sensor may be positioned and equipped to detect the temperature of at least one of the heated enclosed vessel 104, the initial temperature of the first waste product 108, the final temperature of the first waste product 108, a temperature of the first waste product 108 within the chamber of the heated enclosed vessel 104, the second waste product 142, one or more components of the thermal processing system 106, the one or more gas products, or other products of the thermal processing system 106. In some embodiments, the sensors include one or more pressures sensors. The pressure sensors may be positioned and equipped to detect the pressure of at least one of the first waste product 108 in the first waste source 102, the first waste product 108 flowing from the first waste source 102 to the heated enclosed vessel 104, the chamber of the heated enclosed vessel 104, the first waste product 108 (e.g., the liquid phase 110 and/or the vapor phase 112) flowing from the heated enclosed vessel 104 to the thermal processing system 106, the second waste product 142 in the second waste source 140, the second waste product 142 flowing from the second waste source 140 to the thermal processing system 106, or one or more gas products or other products in the thermal processing system 106. The sensors may include other sensors, such as chemical sensors positioned and equipped to detect the composition of at least one of the first waste product 108 (e.g., the liquid phase 110 and/or vapor phase 112), the second waste product 142, or the one or more gas products or other products of the thermal processing system 106; acoustic sensors; electric property sensors, such as voltmeter or current sensor; moisture sensors, such as a humidity sensor; imaging sensors; or any other suitable sensor.

As previously discussed, the gas product manufacturing system 100 may include a controller 126 equipped to control one or more components of the gas product manufacturing system 100. The controller 126 may include a computer (e.g., special purpose computer), electronic circuitry, or any other suitable controller 126. In some embodiments, as previously discussed, the controller 126 is equipped to control at least one of the first valve 124, the second valve 136, the third valve 138, and the fourth valve 148 to at least partially control at least one of the flow of the waste products through the gas product manufacturing system 100, the pressure within the chamber of the heated enclosed vessel 104, or the percentage of the first waste product 108 that is vaporized. In some embodiments, the controller 126 is equipped to control the temperature of at least one of the heated enclosed vessel 104 or one or more components of the thermal processing system 106 (e.g., one or more gasifiers). In such an example, the controller 126 may be equipped to control the fuel, steam, electrical power, or other energy provided to the heated enclosed vessel 104 and/or the thermal processing system 106 to control the temperatures therein or feed rate therethrough.

In some embodiments, the controller 126 is communicably coupled (e.g., electrically) to the sensors such that the controller 126 may receive the one or more characteristics sensed by the sensors. In such an embodiment, the controller 126 may automatically control the one or more components of the gas product manufacturing system 100 responsive to receiving the one or more characteristics of the sensors, such as to prevent overheating of the first waste product 108 in the heated enclosed vessel 104. In some embodiments, the sensors may detect that the flow of the first waste product 108 or the second waste product 142 in or between one or more components of the gas product manufacturing system 100 is too high or too low. In response, the controller 126 may direct at least one of the first valve 124, the second valve 136, the third valve 138, and the fourth valve 148 to at least partially open or at least partially close to modulate the flow of the first waste product 108 or the second waste product 142. In some embodiments, the sensors may detect that the temperature of the heated enclosed vessel 104 and/or the pressure in the chamber is too high or too low. In such an example, the controller 126 may control the valves or energy provided to the heated enclosed vessel 104 to correct the temperature and/or pressure thereof. In some embodiments, the sensors may detect that too much or too little of the first waste product 108 is being vaporized. In response, the controller 126 may control the valves, change the temperature of the heated enclosed vessel 104, and/or the pressure in the chamber to change the percentage of the first waste product 108 is being vaporized.

It is noted that the gas product manufacturing system 100 may include one or more components that are not illustrated. In some embodiments, the gas product manufacturing system 100 may include one or more compressors or pumps that control the flow of the first waste product 108 and/or the second waste product 142 and control the pressure in one or more components of the gas product manufacturing system 100 (e.g., within the chamber). The compressors or pumps may be at least partially controlled by the controller 126. In some embodiments, the gas product manufacturing system 100 may include one or more tanks sized, shaped, positioned, equipped, or otherwise configured to store the syngas 114 or one or more other products of the thermal processing system 106.

FIG. 2 is a schematic illustration of a gas product manufacturing system 200, according to an embodiment. Except as otherwise disclosed herein, the gas product manufacturing system 200 is the same as or substantially similar to any of the gas product manufacturing systems disclosed herein. For example, the gas product manufacturing system 200 includes a first waste source 202, a heated enclosed vessel 204, and a thermal processing system 206. The first waste source 202 is sized, shaped, positioned, and equipped to provide a first waste product 208 to the heated enclosed vessel 204 and the heated enclosed vessel 204 is equipped to output a liquid phase 210 and a vapor phase 212 of the first waste source 202 to the thermal processing system 206. The gas product manufacturing system 200 may also include a second waste source 240 equipped to output a second waste product 242 to the thermal processing system 206.

The thermal processing system 206 includes a first gasifier 250. The first gasifier 250 is sized, shaped, positioned, and equipped to receive the liquid phase 210 and the vapor phase 212 of the first waste product 208. In other words, the first gasifier 250 includes the first thermal processing inlet 232 and the second thermal processing inlet 234. The first gasifier 250 may also be sized, shaped, positioned, and equipped to receive the second waste product 242. In other words, the first gasifier 250 may include the third thermal processing inlet 246. The first gasifier 250 is equipped to at least partially gasify the first waste product 208 and the optional second waste product 242 (e.g., gasify the organic material(s) thereof) to form one or more first gas products 252 (e.g., syngas). As previously discussed, the heating of the first waste product 208 to form the liquid phase 210 exhibiting the final temperature and the vapor phase 212 reduces the time and energy needed for the first gasifier 250 to gasifier the first waste product 208. The reduced time and energy needed for the first gasifier 250 to gasify the waste products decreases the workload on the first gasifier and improves the thermal processing system's 206 throughput.

The first gasifier 250 may include a joule heating gasifier, an induction heating gasifier, or any other suitable gasifier. In some embodiments, the first gasifier 250 defines a processing chamber sized, shaped, positioned, and equipped (e.g., configured) to convert at least a portion of the first waste product 208 and the second waste product 242 into the first gas products 252. The first gasifier 250 includes a at least one port to provide material to the processing chamber and at least one electrode. For example, the first gasifier 250 may include one or more of at least one first port to provide the first and second waste products 208, 242 into the processing chamber, at least one second port to provide oxygen, or at least one third port to provide material (e.g., inorganic material). The first gasifier 250 may include one or more of at least one first electrode to induce reactions between the at least the first waste product 208 and the oxygen to form at least syngas or at least one second electrode to provide joule heating that is sufficient to form and maintain a molten inorganic (e.g., glass) bath within the processing chamber. The first gasifier 250 may include an outlet 254 that allows the one or more gas products 252 generated in the processing chamber to leave the processing chamber.

In some embodiments, the thermal processing system 206 includes an optional second gasifier 256 that is downstream and distinct from the first gasifier 250. The second gasifier 256 is sized, shaped, positioned, and equipped to receive at least some of the first gas products 252 generated by the first gasifier 250 and to further process the first gas products 252 to form one or more second gas products 258 (e.g., syngas). The further processing of the first gas products 252 may at least one of reform the methane in the first gas products 252, crack any remaining high-molecular-weight compounds in the first gas products 252, remove solids from the first gas products 252, approach the water-gas shift equilibrium, or otherwise further process the first gas products 252. The second gasifier 256 may also reduce the workload of the first gasifier 250 thereby reducing wear on the first gasifier 250 and allowing the first gasifier 250 to more quickly gasify the first and second waste products 208, 242. The first and second gasifiers 250, 256 may be directly or indirectly in fluid communication with each other.

The second gasifier 256 may include any of the gasifiers disclosed herein. In some embodiments, the second gasifier 256 is the same as or substantially similar to the first gasifier 250. In some embodiments, the second gasifier 256 is different than the first gasifier 250 which may allow the second gasifier 256 to process the first gas products 252 differently than the first gasifier 250.

In some embodiments, the second gasifier 256 includes a vessel (e.g., refractory-lined vessel, a carbon-steel vessel, a vertical vessel, or combinations thereof). The second gasifier 256 may be equipped to introduce small quantities of oxygen into the vessel to heat the second gasifier 256. The second gasifier 256 may be sized, shaped, and equipped provide sufficient residence time and temperature to further process the first gas product 252, as previously discussed. The second gasifier 256 may also be configured to reduce the velocity of the first gas product 252 by increasing the diameter of the gas of the second gasifier over that of gas product 252. The second gasifier 256 may exhibit a temperature of about 850° C. to about 1500° C. which allows the second gasifier 256 to further process the first gas products 252. The second gasifier 256 may include a gas-fired device that may preheat the second gasifier 256 to operating temperatures and assist in further gasification of the first gas product 252.

The thermal processing system 206 may include a gas cooler and/or cleaner 260. The gas cooler and/or cleaner 260 is sized, shaped, positioned, and equipped (e.g., configured) to receive the second gas products 258 output from the second gasifier 256 or, if the thermal processing system 206 does not include the second gasifier 256, the first gas products 252 output from the first gasifier 250. The gas products received by the gas cooler and/or cleaner 260 may exhibit a relatively high temperature and/or include impurities. The gas cooler and/or cleaner 260 is equipped to at least one of cool the gas products received thereby to a more manageable temperature for further processing or handling or to remove the impurities from the gas products. It is noted that at least some impurities may be removed from the gas products as the gas products are cooled.

In some embodiments, the gas cooler and/or cleaner 260 includes a partial quenched cooler and cleaner. The partial quenched cooler and cleaner may include an atomizer and a partial quench chamber. The atomizer is positioned and equipped to cool the hot gas products in the partial quench chamber using atomized water. The atomizer and the partial quench chamber may cool the gas products to a temperature of about 120° C. to about 250° C. to form a partially quenched gas product. The partial quenched cooler and cleaner also includes a filter (e.g., fabric filter) and the partially cooled gas products may pass through a filter to remove solid particles therefrom. The partially cooled and filtered gas products may then be fully quenched with water to form a fully cooled gas product. The partial quench cooler and cleaner may also include a packed bed scrubber and the partially or fully quenched gas product may pass through the packed bed scrubber. The fully cooled gas product may exhibit a temperature at or near ambient temperature. The fully cooled gas may also have acids at least partially removed therefrom. The acid may be removed through absorption in an aqueous solution or reacted with water and or caustic materials such as sodium hydroxide, calcium hydroxide or other caustic materials. A dry scrubbing apparatus may also be used to remove acid gases such as a slaked lime scrubber system.

In some embodiments, the gas cooler and/or cleaner 260 includes a fully quenched cooler and cleaner. The fully quenched cooler and cleaner is sized, shaped, positioned, and equipped (e.g., configured) to receive the hot gas products and substantially immediately cool the hot gas products to less than 100° C. For example, the hot gas products may be cooled using a spray of recirculating cooled water. The gas product may be cleaned using a Venturi-scrubber (e.g., a high-energy Venturi scrubber) to remove acids and other impurities from the fully cooled gas products. The gas product may be fully cooled using the recirculating water and cleaned using the Venturi-scrubber substantially simultaneously. It is noted that the recirculating cooled water may be cooled using a heat exchanger and pass through filters after cooling the hot gas products. Water in the hot gas products may be removed from the gas products while the gas products are being cooled or in the Venturi-scrubber. Excess water in the fully quenched cooler and cleaner may be sent or directed to a wastewater collection system.

It is noted that the fully quenched cooler and cleaner may be an improvement over the partial quenched cooler and cleaner. In some embodiments, the fully quenched cooler and cleaner uses less water and thereby generates less wastewater than the partial quenched cooler and cleaner. In some embodiments, the fully quenched cooler and cleaner may be substantially smaller than the partially quenched cooler and cleaner. In some embodiments, the fully quenched cooler and cleaner may require less control than the partially quenched cooler and cleaner because the fully quenched cooler and cleaner removes the corrosive materials from the gas products faster/sooner than the partially quenched cooler and cleaner.

In some embodiments, the thermal processing system 206 includes a sulfur removal device 262 that may be downstream from the gas cooler and/or cleaner 260. The sulfur removal device 262 may be sized, shaped, positioned, and equipped (e.g., configured) to receive the cooled and/or cleaned gas products 264 from the gas cooler and/or cleaner 260. In other words, the sulfur removal device 262 and the gas cooler and/or cleaner 260 are in direct or indirectly fluid communication with each other. In some embodiments, the thermal processing system 206 may include a compressor 266 that is positioned and equipped to increase the pressure of the cooled and/or cleaned gas products 264, for example, to about 10 psig (69 kPa) to about 75 psig (517 kPa). It is noted that the compressor 266 may decrease the overall energy required to operate the thermal processing system 206 by allowing the sulfur removal device 262 to operate more efficiently.

The sulfur removal device 262 is equipped to remove sulfur from the cooled and/or cleaned gas products 264. In some embodiments, the sulfur removal device 262 may include a plurality of devices. The plurality of devices may include a catalytic reactor to convert COS in the cooled and/or cleaned gas products 264 to H₂S. The plurality of devices may also include a heat exchanger (e.g., shell and tube heat exchanger) downstream from the catalytic reactor that cools the gas products to less than about 50° C. The plurality of devices may also include a knockout pot (e.g., vapor-liquid separator) that is, for example, downstream from the heat exchanger. The knockout pot is sized, shaped, positioned, and equipped (e.g., configured) to remove the condensed water from the product gas. The plurality of devices may also include a sulfur absorber tower that is, for example, downstream from the knockout pot. The absorber tower is equipped to scrub hydrogen sulfide (H₂S) from the product gas by contacting the product gas with a counter-current flowing liquid solution. The sulfur absorbed into the counter-current flowing liquid solution is converted to elemental sulfur. The counter-current flowing liquid solution may pumped to a separate vessel where the elemental sulfur is separated from the counter-current flowing liquid solution. The recovered sulfur may be processed to form a moist cake that may be used, for example, as an agricultural fertilizer. The gas product leaving the absorber tower may exhibit a very small pressure drop. Although the removal efficiency of the absorber tower is very high, the hydrogen sulfide content in the gas product may still too high for further processing and may be high enough that the hydrogen sulfide would need to be captured. As such, the plurality of devices may include one or more solid phase sulfur absorbent beds in a lead-lag configuration to remove substantially all of the hydrogen sulfide from the gas product. The cleaned gas product 268 exiting the sulfur removal device 262 may have a hydrogen sulfide content that is below about 1 ppm.

The cleaned gas product 268 may be received by a hydrogen producer 270. In other words, the hydrogen producer 270 may be downstream from the sulfur removal device 262. The cleaned gas product 268 received by the hydrogen producer 270 may exhibit an elevated pressure, such as a pressure of about 200 psig (1.37 MPa) to about 350 psig (2.41 MPa) which may allow pressure swing adsorption technology to produce hydrogen. To obtain the elevated pressure, the hydrogen producer 270 may include a compressor or the thermal processing system 206 may include a compressor upstream from the hydrogen producer 270 (e.g., between the sulfur removal device 262 and the hydrogen producer 270).

The hydrogen producer 270 is equipped to produce hydrogen from the gas product received thereby. In some embodiments, the hydrogen producer 270 includes a shift reactor followed by a pressure swing adsorber unit. In such embodiments, the hydrogen producer 270 may include one or more devices (e.g., compression and a guard bed) to remove contaminates from the gas product (e.g., hydrogen sulfide and/or hydrogen chloride) that would damage the shift reactor. The shift reactor may include a water-gas shift reactor equipped to react carbon monoxide in the gas product with steam to increase the hydrogen content of the gas product (e.g., syngas). The gas product exiting the shift reactor may then be received by the pressure wing adsorber unit that is equipped to purify the hydrogen product. The pressure swing adsorber unit may use multiple vessels containing adsorbents or absorbents to preferentially adsorb or absorb carbon monoxide, carbon dioxide, and inert gases from the gas product, leaving a relatively pure hydrogen stream (e.g., about 95% or greater or 99% or greater pure hydrogen stream). When the adsorbents or absorbents are fully saturated, the adsorbents or absorbents may be taken off-line for regeneration by de-pressuring, purging and re-pressuring. The hydrogen essentially flows through the adsorbents or absorbents with minimal pressure loss and about 75% or more of the hydrogen is recovered. The purified hydrogen may be then sent to a compressor for storage and transfer into trailers for offsite delivery. The rest of the hydrogen and the other gases (carbon monoxide, carbon dioxide, nitrogen, and water) may be collected as part of the absorbents or adsorbents regeneration process and a form a low pressure “tail gas” 272. As will be discussed in more detail below, the tail gas 272 may be sent for further processing (e.g., to at least one of a boiler, a power generation system, a thermal oxidizer, or a carbon dioxide recovery system 274). In some embodiments, the hydrogen producer 270 does not include the shift reactor.

In some embodiments, a pressure wing adsorber unit of the hydrogen producer 270 may include at least a four-bed design. Each bed may operate on a five-step cycle: (1) adsorption, (2) co-current depressurization, (3) counter-current depressurization, (4) purge at low pressure, and (5) re-pressurization. The cycles may be staggered across the four beds to allow a continuous operation when one of the beds is removed to regenerate the adsorbents thereof. The hydrogen removed from the bed during the co-current depressurization step may be used to re-pressurize other beds by pressure equalizations. The level of recovery (e.g., the amount of hydrogen in the product gas as a percentage of the total amount of hydrogen entering the pressure wing adsorber unit) may be at least partially dependent on the number of beds, the number of pressure equalization steps, and the desired level of purity of the hydrogen. In general, the greater the number of these pressure equalizations, the greater the recovery of hydrogen.

As previously discussed, the tail gas 272 output from the hydrogen producer 270 may be further processed by a carbon dioxide recovery system 274 that is equipped to remove at least some of the carbon dioxide from the tail gas 272. In some embodiments, the carbon dioxide recovery system 274 may include a thermal oxidizer or other device that is equipped to convert at least some of any remaining carbon monoxide in the tail gas 272 into carbon dioxide or hydrogen into water. The thermal oxidizer may be equipped and arranged to limit nitrogen contamination in the tail gas 272 to prevent or at least inhibit dilution of the carbon dioxide. For example, the thermal oxidizers may include a catalytic thermal oxidizer that eliminates or limits the amount of nitrogen added to the tail gas 272.

The thermal processing system 206 may include at least one tail gas processing device 276 instead of or in addition to the carbon dioxide recovery system 274. When the thermal processing system 206 includes both the tail gas processing device 276 and the carbon dioxide recovery system 274, the tail gas processing device 276 and the carbon dioxide recovery system 274 may be arranged in series (as shown) or in parallel. In some embodiments, the tail gas processing device 276 may include a thermal oxidizer. In some embodiments, the tail gas processing device 276 may include at least one of a boiler or a power generation system.

It is noted that one or more components of the thermal processing system 206 may be omitted therefrom and/or one or more components may be added to the thermal processing system 206. In some embodiments, the thermal processing system 206 may include one or more additional gasifiers or the second gasifier may be omitted from the thermal processing system 206. In some embodiments, one or more of the gas cooler and/or cleaner 260, the compressor 266, the sulfur removal device 262, the hydrogen producer 270, the carbon dioxide recovery system 274, or the tail gas processing device 276 may be omitted. In some embodiments, as previously discussed, the thermal processing system 206 may include one or more heat exchangers (e.g., heat exchanger 123 shown in FIG. 1) that are positioned and equipped to recover waste energy from the thermal processing system 206. A heat exchanger may be thermally coupled to, for example, at least one of the first gasifier 250 and/or the second gasifier 256 to receive heat dissipated therefrom or from the molten organic material removed therefrom, the gas cooler and/or cleaner 260 to receive heat removed from the gas products, the sulfur removal device 262 to receive heat removed from the gas products, or any other component of the thermal processing system 206. In some embodiments, the thermal processing system 206 may include one or more sensors and/or a controller.

FIG. 3 is a schematic of a gas product manufacturing system 300, according to an embodiment. Except as otherwise disclosed herein, the gas product manufacturing system 300 is the same as or substantially similar as any of the gas product manufacturing systems disclosed herein. For example, the gas product manufacturing system 300 includes a first waste source 302, a heated enclosed vessel 304, and a thermal processing system 306. The first waste source 302 is sized, shaped, positioned, and equipped to provide a first waste product 308 to the heated enclosed vessel 304 and the heated enclosed vessel 304 is sized, shaped, positioned and equipped to output a liquid phase 310 and a vapor phase 312 of the first waste source 302 to the thermal processing system 306. The gas product manufacturing system 300 may also include a second waste source 340 that is sized, shaped, positioned, and equipped to output a second waste product 342 to the thermal processing system 306. Also, except as otherwise disclosed herein, the thermal processing system 306 may be the same as or substantially similar to any of the thermal processing systems disclosed herein in one or more aspects, such as thermal processing system 206. For example, the thermal processing system 306 may include a first gasifier 350, a second gasifier 356, and one or more additional components 378 (e.g., gas cooler and/or cleaner, sulfur removal device, hydrogen producer, etc.).

The first gasifier 350 is sized, shaped, positioned, and equipped (e.g., configured) to receive the liquid phase 310 of the first waste product 308 and, optionally, the second waste product 342. As such, the first gasifier 350 may include the first and third thermal processing inlets 332, 346. Meanwhile, the second gasifier 356 is sized, shaped, positioned, and equipped to receive the vapor phase 312 of the first waste product 308 and, as such, the second gasifier 356 includes the second thermal processing inlet 334. In other words, the thermal processing system 306 is positioned and equipped to have the vapor phase 312 of the first waste product 308 bypass the first gasifier 350. Receiving the vapor phase 312 at the second gasifier 356 instead of the first gasifier 350 decreases the workload of the first gasifier 350. The decreased workload of the first gasifier 350 may improve the life span of the first gasifier 350 and may decrease the energy and oxygen required to operate the first gasifier 350. Since the vapor phase 312 is already gaseous, providing the vapor phase 312 directly to the second gasifier 356 has negligible effect on the gas product output from the second gasifier 356 even though the vapor phase 312 is only processed by one gasifier instead of two.

While FIGS. 1-3 depict systems for gas product manufacturing, FIGS. 1-3 also depict methods for forming gas products from liquid waste streams. The gas products include syngas, which may be stored for use, burned for fuel, or further processed to form liquid fuel(s).

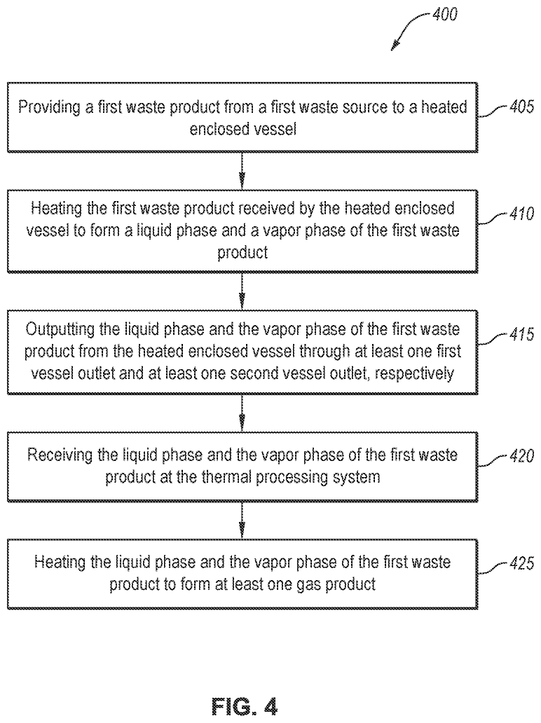

FIG. 4 is a flow chart of a method 400 to manufacture a gas product, according to an embodiment. The method 400 includes blocks 405, 410, 415, 420, and 425. Block 405 includes “providing a first waste product from a first waste source to a heated enclosed vessel.” Block 410 includes “heating the first waste product received by the heated enclosed vessel to form a liquid phase and a vapor phase of the first waste product.” Block 415 includes “outputting the liquid phase and the vapor phase of the first waste product from the heated enclosed vessel through at least one first vessel outlet and at least one second vessel outlet, respectively.” Block 420 includes “receiving the liquid phase and the vapor phase of the first waste product at the thermal processing system.” Block 425 includes “heating the liquid phase and the vapor phase of the first waste product to form at least one gas product.”

It is noted that blocks 405, 410, 415, 420, 425 are provided for illustrative purposes. As such, one or more of the blocks may be omitted, supplemented, modified, or combined. Further, it is noted that the method 400 may include one or more additional blocks instead of or in addition to one or more of blocks 405, 410, 415, 420, 425. Additional details of the method 400 are disclosed in the discussion of gas product manufacturing systems 100, 200, 300 of FIGS. 1-3. These additional details discussed with regards to gas product manufacturing systems 100, 200, 300 may be used to supplement the method 400, without limitation. The method 400 may include utilizing any of the systems, or portions thereof, disclosed herein.

Block 405 includes “providing a first waste product from a first waste source to a heated enclosed vessel.” The first waste product may be provided to the heated enclosed vessel from one or more pipes, at least one tank, or any other source of the first waste product. The first waste product provided to the heated enclosed vessel may exhibit an initial temperature. Block 405 may include providing any of the first waste products disclosed herein to the heated enclosed vessel. For example, block 405 may include providing a first waste product that include at least one solvent and one or more of at least one organic material or at least one inorganic material. In some embodiments, the first waste product may include at least one high heat capacity material (e.g., water) forming, by weight, at least about 20% of the first waste product.

Block 410 includes “heating the first waste product received by the heated enclosed vessel to form a liquid phase and a vapor phase of the first waste product.” For example, the heated enclosed vessel includes a chamber. The first waste product may be received into the chamber and heated. The temperature of the heated enclosed vessel, the pressure within the chamber, and other characteristics of the heated enclosed vessel (e.g., the dwell time of the first waste product in the chamber) are selected to cause a portion of the first waste product to vaporize. Block 410 may include heating the first waste product to a final temperature that is greater than the initial temperature.

Block 415 includes “outputting the liquid phase and the vapor phase of the first waste product from the heated enclosed vessel through at least one first vessel outlet and at least one second vessel outlet, respectively.” As previously discussed, the heated enclosed vessel includes a first vessel outlet and a second vessel outlet. The first vessel outlet is positioned and equipped to output at least some of the liquid phase of the first waste product and the second vessel is positioned and equipped to output at least some of the vapor phase of the first waste product. In some embodiments, the second vessel outlet is positioned gravimetrically higher in the heated enclosed vessel and/or downstream from the first vessel outlet. In such an example, the first vessel outlet may remove the liquid phase of the first waste product when the liquid phase pools to the first vessel outlet or otherwise reaches the first vessel outlet. Generally, the liquid phase of the first waste product is substantially removed from the chamber by the first vessel outlet before the liquid phase can reach the second vessel outlet. As such, such positioning of the first and second vessel outlets causes the first and second vessel outlets to primarily remove the liquid and vapor phases, respectively, of the first waste product.

Block 420 includes “receiving the liquid phase and the vapor phase of the first waste product at the thermal processing system.” The liquid phase and the vapor phase may be received into any of the components of the thermal processing system. In some embodiments, as shown in FIG. 2, the liquid and vapor phase are received into the same component (e.g., the first gasifier) of the thermal processing system. In some embodiments, as shown in FIG. 3, the liquid and vapor phases are received into different components (e.g., the first and second gasifiers) of the thermal processing system.

Block 425 includes “heating the liquid phase and the vapor phase of the first waste product to form at least one gas product.” The liquid phase and the vapor phase may be heated by at least one gasifier of the thermal processing system. In some embodiments, the liquid phase may be heated by the first gasifier and, if included, the second gasifier of the thermal processing system. In some embodiments, the vapor phase may be heated by the first gasifier and/or the second gasifier. Heating the liquid phase and the vapor phase may form one or more gas products. For example, heating the liquid phase and the vapor phase may form syngas. The syngas may include one or more impurities and/or require further processing, as discussed in more detail with regards to the gas product manufacturing system 200 of FIG. 2. It is noted that block 425 may include forming one or more products other than syngas, such as inorganic material (e.g., glass) that may be extracted from the gasifiers, as previously discussed.

The method 400 may include one or more additional blocks. In some embodiments, the method 400 may include providing a second waste product to the thermal processing system while bypassing the heated enclosed vessel. In some embodiments, the method 400 may include at least one of cooling, cleaning, compressing, removing sulfur or other impurities from, producing hydrogen from, removing carbon dioxide from, or otherwise processing the gas products output from the gasifier(s) of the thermal processing system. Additional blocks are evident from the discussion of gas product manufacturing systems 100-300.

In some embodiments, methods to manufacture a gas product may include fewer blocks than those disclosed in the method 400. For example, a method to manufacture a gas product may include a first block of “providing a first waste product to at least one heated enclosed vessel,” as second block of “heating the first waste product received by the at least one heated enclosed vessel to form a liquid phase and a vapor phase of the first waste product,” a third block of “outputting the liquid phase and the vapor phase of the first waste product from the at least one heated enclosed vessel to at least one thermal processing system,” and a fourth block of “heating the liquid phase and the vapor phase of the first waste product in the thermal processing system to form at least one gas product.”

Providing a first waste product to at least one heated enclosed vessel may be similar or identical to the block 405 in one or more aspects. Heating the first waste product received by the at least one heated enclosed vessel to form a liquid phase and a vapor phase of the first waste product may be similar or identical to the block 410 in one or more aspects. Outputting the liquid phase and the vapor phase of the first waste product from the at least one heated enclosed vessel to at least one thermal processing system may be similar or identical to one or more of the blocks 415 or 420 in one or more aspects. Heating the liquid phase and the vapor phase of the first waste product in the thermal processing system to form at least one gas product may be similar or identical to the block 425 in one or more aspects. In some examples, the providing step may be omitted. In some examples, any of the techniques disclosed herein with respect to the method 400 or FIGS. 1-3 may be utilized in the above-described simplified methods of manufacturing a gas product.

The methods and systems disclosed herein may be used to create one or more gas products, such as syngas, gaseous fuel, liquid fuel, or chemical feedstocks. The methods and systems disclosed herein may be used to treat waste streams having liquid content in an energy manner than prevents explosions while allowing potentially harmful solids or inorganic materials to be isolated in the molten bath of a gasifier. For example, by providing at least some of the latent heat of vaporization to the liquid waste prior to introduction into a gasifier, the energy required to gasify the organic components of the waste is reduced, thereby allowing for faster throughput time in the gasifier compared to methods that do not vaporize portions of the waste stream.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In some embodiments, when the term of degree is included with a term indicating quantity, the term of degree is interpreted to mean ±10%, ±5%, or +2% of the term indicating quantity. In some embodiments, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

1. A gas product manufacturing system, comprising:
at least one first waste source configured to provide a first waste product, the first waste product including at least one solvent and one or more of at least one inorganic material or at least one organic material;
at least one heated enclosed vessel including at least one vessel inlet in fluid communication with the first waste source, the at least one heated enclosed vessel configured to form a liquid phase and a vapor phase of the first waste product, the at least one heated enclosed vessel including at least one first vessel outlet positioned and equipped to output the liquid phase and at least one second vessel outlet positioned and equipped to output the vapor phase; and
at least one thermal processing system including at least one first processing inlet in fluid communication with the at least one first vessel outlet and at least one second processing inlet in fluid communication with the at least one second vessel outlet, the at least one thermal processing system configured to heat the liquid phase of the first waste product and the vapor phase of the first waste product to form at least one gas product.

2. (canceled)

3. The gas product manufacturing system of claim 1, wherein the at least one solvent of the first waste product includes water and the water forms at least 20% of the first waste product.

4. The gas product manufacturing system of claim 1, wherein the at least one heated enclosed vessel includes a reboiler, a flash vaporizer, or a steam generator.

5. The gas product manufacturing system of any claim 1, wherein the at least one thermal processing system includes at least one heat exchanger, the at least one heat exchanger positioned and equipped to receive waste thermal energy from one or more components of the at least one thermal processing system and provide at least some of the waste thermal energy to the at least one heated enclosed vessel.

6. The gas product manufacturing system of claim 1, wherein the at least one thermal processing system includes a first gasifier, the first gasifier including the at least one first processing inlet.

7. The gas product manufacturing system of claim 6, wherein the first gasifier includes the at least one second processing inlet.

8. The gas product manufacturing system of claim 6, wherein the first gasifier is connected to a molten inorganic bath.

9. The gas product manufacturing system of claim 6, wherein the at least one thermal processing system includes a second gasifier, the second gasifier in fluid communication with the first gasifier.

10. The gas product manufacturing system of claim 9, wherein the first gasifier includes at least one thermal inlet for receiving the liquid phase of the first waste product and the vapor phase of the first waste product.

11. The gas product manufacturing system of claim 1, further comprising second waste source configured to provide a second waste product to the at least one thermal processing system, the second waste product being different than the first waste product.

12. The gas product manufacturing system of claim 1, wherein the at least one thermal processing system further includes a gas cooler and/or cleaner, the gas cooler and/or cleaner including a fully quenched chamber and a Venturi-scrubber.

13. The gas product manufacturing system of claim 1, wherein the at least one gas product includes synthesis gas.

14. A method to manufacture a gas product, the method comprising:
providing a first waste product from a first waste source to at least one heated enclosed vessel through at least one vessel inlet of the at least one heated enclosed vessel, the first waste product including at least one solvent and one or more of at least one inorganic material or at least one organic material;
heating the first waste product received by the at least one heated enclosed vessel to form a liquid phase and a vapor phase of the first waste product;
outputting the liquid phase and the vapor phase of the first waste product from the at least one heated enclosed vessel through at least one first vessel outlet and at least one second vessel outlet of the at least one heated enclosed vessel;
receiving the liquid phase and the vapor phase of the first waste product with at least one first thermal inlet and at least one second thermal inlet of at least one thermal processing system; and
heating the liquid phase and the vapor phase of the first waste product to form at least one gas product.

15. (canceled)

16. The method of claim 14 wherein the first waste source includes at least one high heat capacity material, and wherein the at least one high heat capacity material forms at least about 15% of the first waste source.

17. (canceled)

18. The method of claim 14, wherein heating the first waste product includes heating the first waste product such that about 25% to about 75%, by weight, of the first waste product is vaporized to form the vapor phase.

19. The method of any claim 14, wherein:
providing the first waste product from the first waste source to the at least one heated enclosed vessel includes providing the first waste product exhibiting an initial temperature to the heated enclosed vessel; and
outputting the liquid phase of the first waste product from the at least one heated enclosed vessel includes outputting the liquid phase at a final temperature that is greater than the initial temperature.

20. The method of claim 14, wherein:
the at least one thermal processing system includes a first gasifier including the at least one first thermal inlet;
receiving the liquid phase of the first waste product includes receiving the liquid phase at the at least one first thermal inlet of the first gasifier; and
heating the liquid phase of the first waste product includes heating the liquid phase of the first waste product at the first gasifier to form the at least one first gas product.

21. The method of claim 20, wherein the first gasifier includes the at least one second thermal inlet, and wherein:
receiving the vapor phase of the first waste product includes receiving the vapor phase of the first waste product at the at least one second thermal inlet of the first gasifier; and
heating the vapor phase of the first waste product includes heating the vapor phase of the first waste product at the first gasifier.

22. The method of claim 20, wherein:
the thermal processing system includes a second gasifier including the at least one second thermal inlet;
receiving the vapor phase of the first waste product includes receiving the vapor phase of the first waste product at the at least one second thermal inlet of the second gasifier; and
heating the vapor phase of the first waste product includes heating the vapor phase of the first waste product at the second gasifier.

23. The method of claim 22, further comprising:
receiving at least one first gas product from the first gasifier at the second gasifier; and
simultaneously with heating the vapor phase, heating the at least one first gas product at the second gasifier.

24. (canceled)

25. (canceled)

26. (canceled)

27. (canceled)

28. (canceled)

29. (canceled)

30. (canceled)

31. (canceled)
